(19) United States
(12) Patent Application Publication
(10) Pub. No.: US 2008/0147512 A1
(43) Pub. Date: Jun. 19, 2008

(54) SYSTEMS, METHODS AND COMPUTER IMPLEMENTED APPRATUSES FOR THE CUSTOMIZATION AND PURCHASING OF BOARDS

(76) Inventor: Scott Yankton, Carlsbad, CA (US)

Correspondence Address: LAW OFFICE OF MICHAEL P. EDDY;MICHAEL P. EDDY, 12526 HIGH BLUFF DRIVE, STE. 300, SAN DIEGO, CA, 92130, US

(21) Appl. No.: 11/870,407

(22) Filed: Oct. 10, 2007

Related U.S. Application Data
(60) Provisional application No. 60/828,974, filed on Oct. 10, 2006.

(51) Int. Cl. G06Q 30/00

(52) U.S. Cl. 705/26

(57) ABSTRACT

Systems, methods and computer enabled apparatuses for customizing boards such as surfboards programs are embodiments of the claimed subject matter. One aspect of the claimed subject matter includes a system for fabricating a customized board comprised of an input device for allowing a user to input information about the customized board to be fabricated, a central processing unit operatively connected to the input device by a communications network, the central processing unit receiving said information and generating fabrication instructions in response to the input of the information, and a fabrication machine operatively connected to the central processing unit for fabricating the customized board in accordance with the fabrication instructions. In other embodiments, the user places an order at a kiosk and the information is stored locally before being physically transported and uploaded or electronically sent to the software program and fabrication machine. In the described embodiments the customized board may be a surfboard, a snowboard, a wake board, a hand board, a skateboard, a paddle board, or a stand up paddle board. Examples of attributes from which the user may customize include the size, shape and choice of a predefined board shape and style. The predefined shapes may also be categorized by the names of the template shapers. The attribute menu may also include a number of predefined board styles, shapes and/or dimensions. In other embodiments, the user may also upload board specification data such as data found in three dimensional computer aided design files or 3D CAD files.

### BACKGROUND OF THE INVENTION

The claimed subject matter generally relates to the manufacture and sale of boards including surfboard, wave boards, paddle board and any other type of recreational boards. More particularly, embodiments relate to systems, methods and programs of customizing surfboards for sale to end users. Boards such as surfboards and sailboards are generally made with several components including a high strength exterior covering for protection surrounding a low-density material in the interior core. Woven fabric made from high-strength glass, carbon or aramid fiber is typically embedded in the plastic to form a fiber-reinforced plastic or plastic composite skin giving added strength to the board. Additional coatings are also used to further strengthen the board as well as to give the boards shape and texture.

Currently, methods of purchasing custom surfboards include end users purchasing surfboards online by the user first selecting a preset surfboard model and then progressing in the order cycle to place the order for that preset or preconfigured surfboard. Many prospective consumers of surfboards purchase online through online classified ads or auctions such as those found on the popular website www.craigslist.org and www.ebay.com. In this scenario, a user could search for a particular model, length or shape of a board, find the listing and contact the seller to finalize the purchase. Other purchases of preconfigured surfboards can be initiated and completed online. In one example known in the prior art, the customer would use a browser to view products in an online website such as an e-commerce store which includes board products for sale. The customer would review the images and descriptions of the products and any other information offered to allow additional review before making a selection of one of the predefined styles and shapes of boards. The purchase is typically made online, via telephone or in person and the surfboard products are delivered by a shipper to the consumer or the consumer picks up the purchased product at the merchant's retail location.

### SUMMARY

Embodiments of the inventive subject matter include systems, methods and computer implemented apparatuses which allow consumers and/or other end users the ability to customize boards such as surfboards and paddle boards using a computer enabled interface and one or more board fabrication machines. Embodiments allow users to have a traditional brick and mortar surf shop experience over a network such as the internet or any other computer based medium such as a remote kiosk so that the customer user can customize the board to his or her specifications before making a final purchase decision. Once the purchase decision is made, the board is fabricated to the user's specifications and made available for pickup or shipped to the customer.

One aspect of the claimed subject matter includes a system for fabricating a customized board comprised of an input device for allowing a user to input information about the customized board to be fabricated, a central processing unit operatively connected to the input device by a communications network, the central processing unit receiving said information and generating fabrication instructions in response to the input of the information, and a fabrication machine operatively connected to the central processing unit for fabricating the customized board in accordance with the fabrication instructions.

Other embodiments of the claimed subject matter include systems with an input device having an order computer which allows the user to input the custom board information into the system. The order computer also includes an electronic order page to prompt the user to enter attribute information desired for the customization of the board.

Several embodiments which prompt the user for the attribute information via the electronic order page prompt the user to select one or more graphic images which are to be fabricated upon or within the customized board.

In other embodiments, the information input by the user defines a customer file and the central processing unit includes a processor and a memory storing a software program. The software program is operable to instruct the processor to import the customer file containing the selected attributes from the input device, generate a fabrication file that includes instructions for the fabrication machine for selecting the at least one surfboard blank and fabricating a customized surfboard and send the fabrication file to the fabrication machine so that the fabrication machine creates a board based on the information contained in the fabrication file.

In other embodiments, the communications network is the internet. In other embodiments, the electronic order page is located at a kiosk and the information is stored locally at the kiosk before being physically transported and uploaded or electronically sent to the software program and fabrication machine.

In the described embodiments the customized board is a surfboard, a wave board, a paddle board, or a stand up paddle board. Examples of attributes from which the user may customize include the size, shape and choice of a predefined board shape and style. The predefined shapes may also be categorized by the names of the template shapers. The attribute menu may also include a number of predefined board styles, shapes and/or dimensions. In other embodiments, the user may also upload board specification data such as data found in three dimensional computer aided design files or 3D CAD files.

Other embodiments include methods of fabricating a board which include the steps of receiving a customer file from a remote user containing design information for a customized board to be fabricated, generating fabrication instructions for fabricating a board based on the customer file, and fabricating the board in accordance with those fabrication instructions. Other embodiments of the claimed subject matter include the aforementioned method of fabricating a board further including the steps of placing the board components within a fabrication machine and selecting the board components for fabricating the board.

Yet other embodiments include the additional step of downloading the fabrication instructions to said fabrication machine prior to the fabrication of the board. Other optional steps in embodiments include inputting fabrication information for the customized board to be fabricated with fabrication information defining the customer file and transmitting the customer file to a central processing unit. Other embodiments include the transmission of the fabrication file to the central processing unit via or over the internet. Other embodiments have fabrication files which include a graphic image of the customized board. Examples of boards fabricated in these embodiments include a surfboard, a wave board, a paddle board and a stand up paddle board.

Yet another embodiment includes a computer enabled apparatus for fabricating a customized board having an input device for allowing a user to input information on the customized board to be fabricated, a central processing unit operatively connected to the input device by a communications network with the central processing unit receiving the information imputed by the user and generating fabrication instructions in response to the inputted information, and a fabrication machine operatively connected to the central processing unit for fabricating the customized board in accordance with the fabrication instructions.

### BRIEF DESCRIPTION OF THE DRAWINGS

The features of the embodiments of the claimed subject matter will be better understood by reference to the accompanying drawings in which:

FIG. 1 is flow chart of steps which can be implemented in an embodiment of the claimed subject matter;

FIG. 2 shows another flow chart of steps used in an embodiment of the claimed subject matter;

FIG. 3 shows another flow chart of steps used in an embodiment of the claimed subject matter;

FIG. 4 is an illustration of a website page showing the various options presented to a customer in an embodiment of the claimed subject matter;

FIG. 5 is a flowchart of the front end portion of a website showing fabrication services available to a prospective user in an embodiment of the claimed subject matter;

FIG. 6 is a flowchart of the customization portion of a website showing the customization and fabrication of a surfboard according to an embodiment of the claimed subject matter;

FIG. 7 is an illustration of a website page showing a list of shapers from which a user can make a selection according to an embodiment of the claimed subject matter;

FIG. 8 is an illustration of a website page showing more detailed information relating to one of the shapers found on the website page of FIG. 7;

FIG. 9 is an illustration of a website page used to initiate the customization of a new board;

FIG. 10 is an illustration of a website page showing various options of board bases available to a user according to an embodiment of the claimed subject matter;

FIG. 11 is an illustration of a website page showing a selected shaper page allowing the user to further customize his or her selection according to an embodiment of the claimed subject matter;

FIG. 12 is an illustration of a website page showing a selection of colors and designs from which the user can select in order to further customize the board according to an embodiment of the claimed subject matter;

FIG. 13 is an illustration of another website page showing another selection of colors and designs from which the user can select in order to further customize the board according to an embodiment of the claimed subject matter;

FIG. 14 is an illustration of website page showing another selection of colors and designs from which the user can select in order to further customize the board according to an embodiment of the claimed subject matter;

FIG. 15 is an illustration of yet another website page showing a selection of colors and designs from which the user can select in order to further customize the board according to an embodiment of the claimed subject matter;

FIG. 16 is an illustration of another website page showing examples of attributes and dimensions which can be selected by the user in order to further customize the board according to an embodiment of the claimed subject matter;

FIG. 17 is an illustration of another website page showing a set of dimensions and attributes which have been selected by the user according to an embodiment of the claimed subject matter;

FIG. 18 is an illustration of a website page which summarized the user's customization selections according to an embodiment of the claimed subject matter;

FIG. 19 is an illustration of a website page showing the payment information used to complete an order according to an embodiment of the claimed subject matter;

FIG. 20 is another illustration of a website page showing the confirmation of the new order screen according to an embodiment of the claimed subject matter; and

FIG. 21 is an illustration of a website page showing the message exchange feature so that customers and shapers may share information regarding the customization information.

### DETAILED DESCRIPTION OF THE EMBODIMENTS

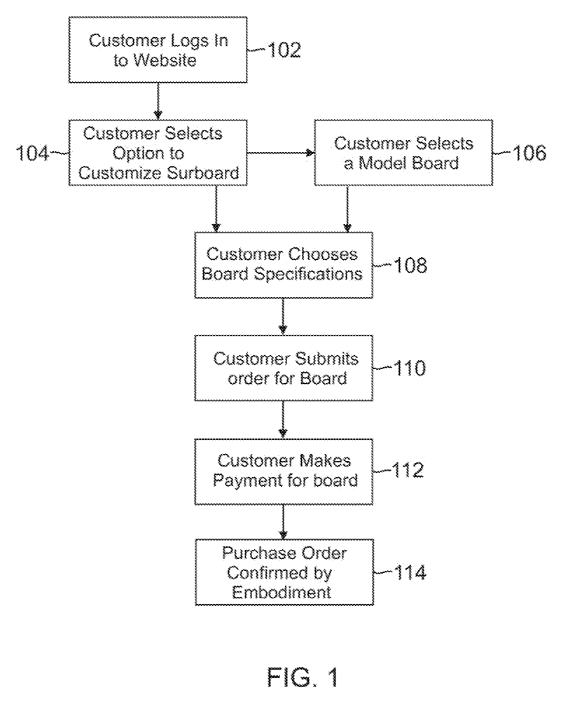

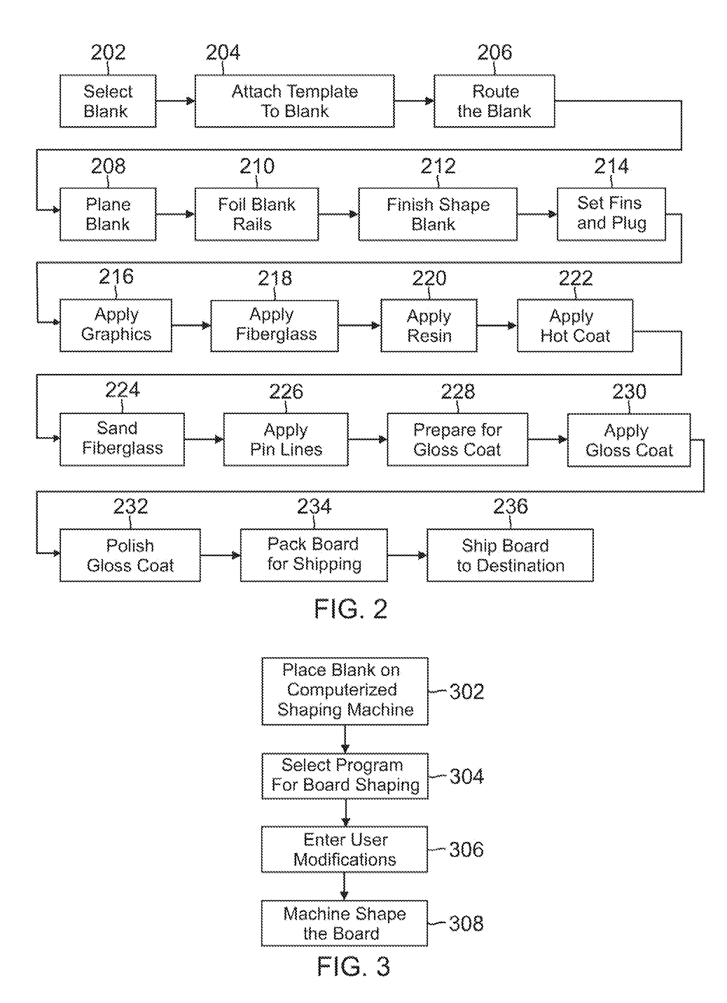

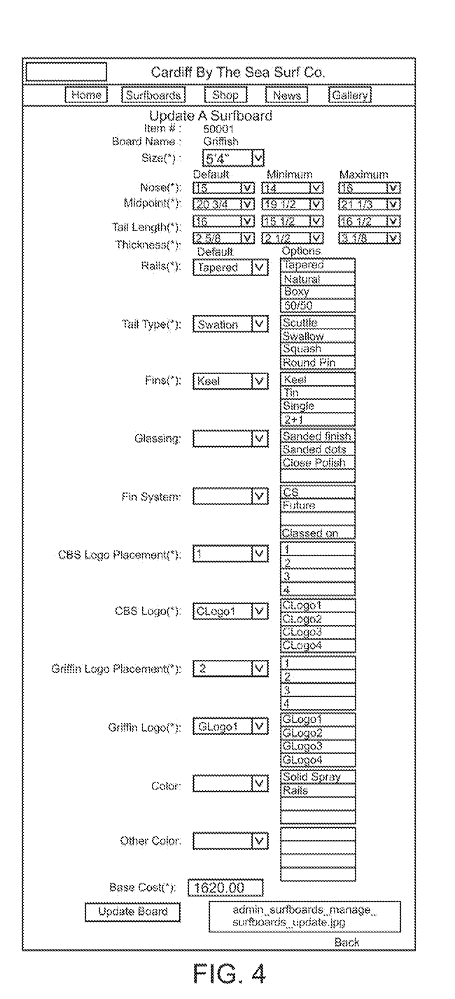

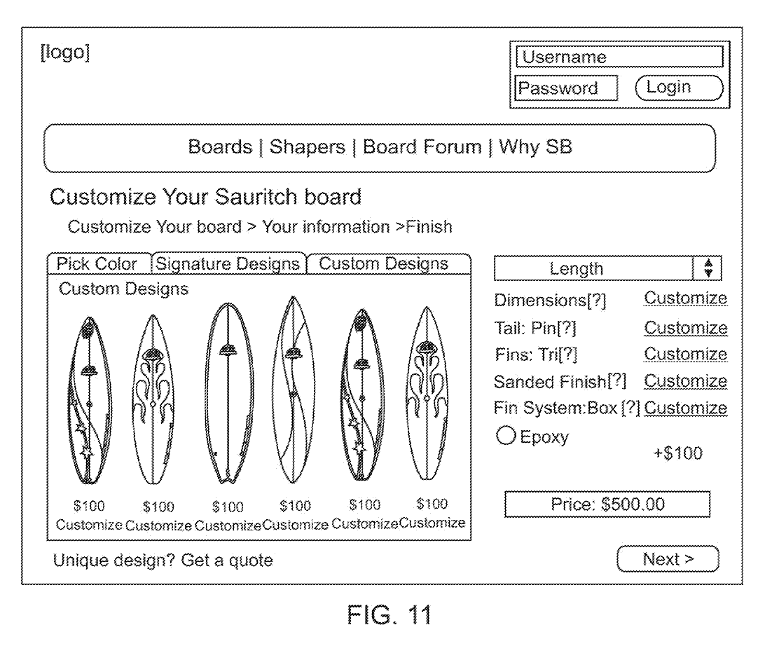

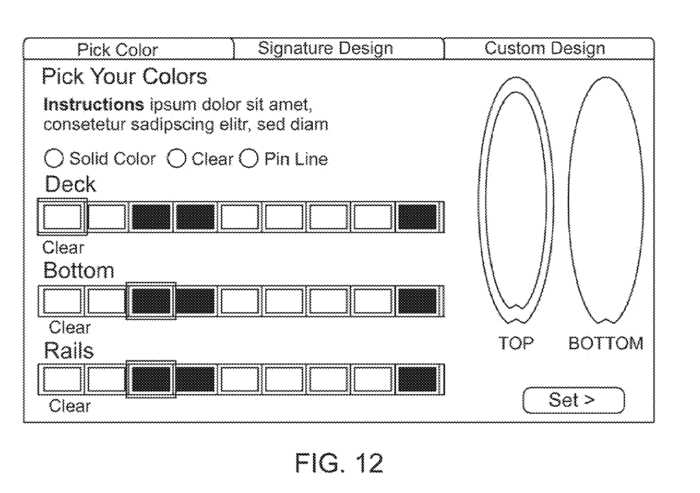

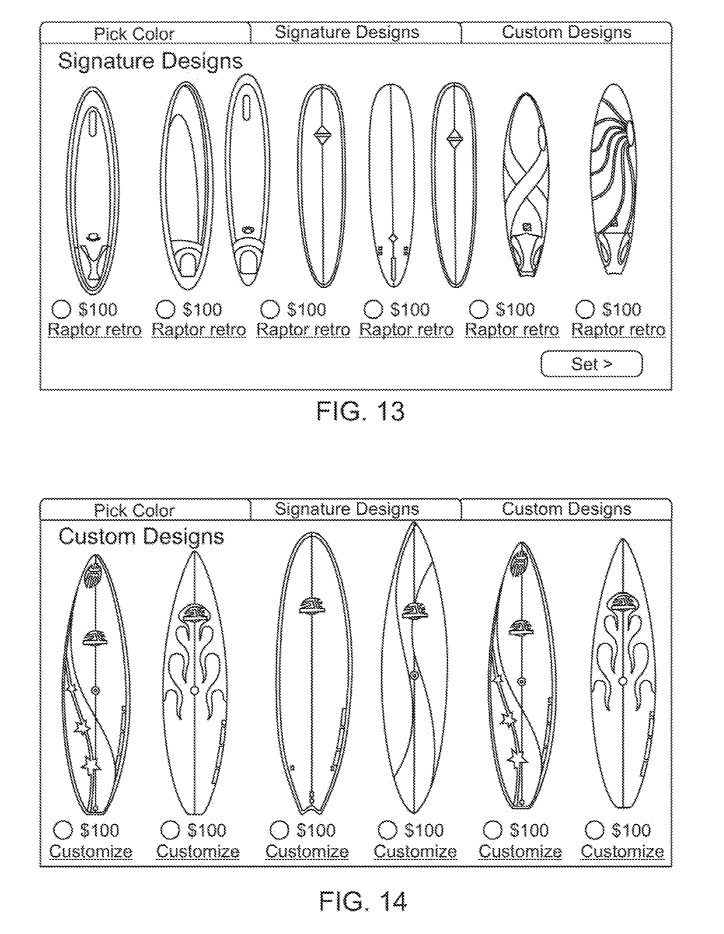

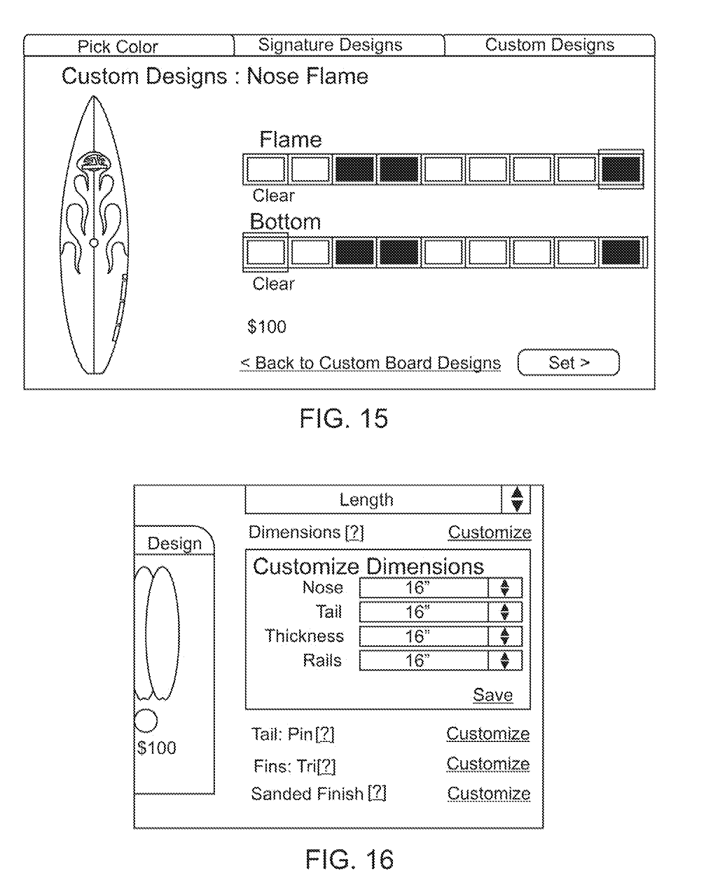

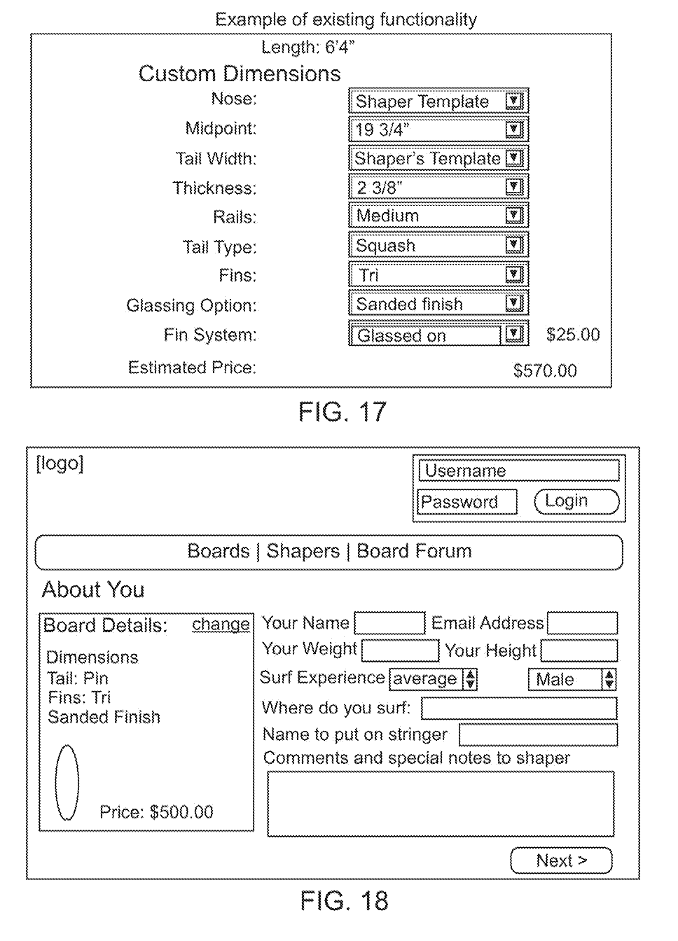

With reference now to the steps shown in FIGS. 1 through 3 and the illustrated web site pages in FIGS. 4 through 21 in which identical elements are numbered identically throughout, a description of various exemplary aspects and embodiments of the claimed subject matter will now be provided.

Embodiments of the claimed subject matter deal with board construction (molding) rather than merely selecting a preexisting mold as seen in the prior art. The present embodiments allow a user to customize and purchase/order one or more hand shaped and machine shaped surfboards (using traditional foam) or any other type of similar board. Embodiments may be used for ordering online, such as via the internet or in person such as using a computer, kiosk or computer based hardware device with embedded software. For example, in one embodiment, the user/purchaser can select and modify dimensions of the surfboard online including any coatings and/or custom graphics. In one embodiment, the customization can be accomplished via a website using a program or script to access a database on the same server or at a different physical location.

Additionally, the present embodiments may use new materials and manufacturing methodologies as well as traditional hand or machine shaped foam blank systems and methods in conjunction with the ability to customize one or more boards over a network or a computer based interface. In an online embodiment, a database and website are used to facilitate the customization, purchase, and order tracking.

Further aspects of the invention will become apparent from consideration of the figures and the ensuing description of the multiple embodiments of the inventive subject matter. A person skilled in the art will realize that other embodiments are possible and that the details of the described embodiments can be modified in a number of respects, all without departing from the scope and spirit of the inventive concept. Thus, the following drawings and description are to be regarded as illustrative in nature rather than restrictive.

Computer implemented embodiments of the inventive subject matter allow a user to access a database via a website and select a model and size of a surfboard as well as “customize” one or more of a group of measurements or aspects/characteristics of the board, for example the graphics, colors, and other aspects which allow a board to be truly customized. After selecting the board, the user can order the board by submitting payment along with other order information such as shipping address and identification information. An order number is created in the embodiments to track the order and to allow the user, now a customer, to track the order and view the stage of the production the board is currently in via the website using an online interface such as an internet browser.

A user can start a new order with no preset dimensions or she/she can customize a predesigned template or board style. Other types of boards which may be customized using embodiments of the inventive subject matter include but are not limited to: wake boards, snow boards, water skis, and snow skis.

Referring now to the drawings, FIG. 1. illustrates an embodiment as used by consumer to make a purchase on an internet website. In step 102, the end user customer logs in to the website containing the programming needed to offer customized boards including a database of options available and an input means so that the user can make any customization choices and complete an order for a board. In step 104, the customer selects an option to customize the surfboard. In this step, the customer may be offered the chance to customize other types of boards. Step 106 is an option step in which the customer can select a predesigned or predetermined board mode. The customer then chooses his or her desired board specifications in step 108. Step 100 illustrates the step of the customer submitting an order for a new customized board and, in step 112, the customer can finalize the purchase by making payment with a credit card through a credit card gateway. In step 114, the order is confirmed.

Steps 202 through 236 illustrate the steps involved in the production and shipping of a customized board. These steps can be performed in some embodiments without intervention from an administrator once the order is placed online. For example, once an order is placed, the dimensions and characteristics associated with the order for a new board could be directly interfaced with a computer controlled board creation machine so that no user intervention is needed to complete the customized board. Other embodiments can pack the customized board into a carton and apply a shipping label to the outside of the carton without user intervention.

Steps 203 through 308 as shown in FIG. 3 illustrate steps undertaken in another embodiment of the inventive subject matter wherein the board blank is used in a machine and the blank is shaped according to the characteristics selected by the board purchaser. These characteristics include but are not limited to dimensions, text and graphics applied to the inside or outside of the board, the type of board, the nature and placement of one or more logos, the color, the type and number of rails, and the leash and the glassing. Additionally, the displayed graphic on the ordering screen may be changed to match the current selections including the previously selected attributes of the board. Similarly, the cost can be calculated on the fly according to the parameters found in the database as well as the selected choices and this cost can be displayed to the end user. An administrator may also view a wholesale cost so that the profit may also be determined and displayed as the order is placed or after the order is placed. In this way, a sales assistant or online affiliate may steer a customer to options that earn higher profits.

In another embodiment, one or more of the above steps can be completed using software embedded in hardware such as a brochure with a touch screen to output information to the user and to receive input from the user relating to the order including customization choices and payment information. In one example, a customer could use a touch screen enabled brochure to select and customize a board so that once completed the brochure could be inserted onto a board customization machine where the selected measurements are applied to the new board.

The brochure may also be presented to a cashier in a storefront scenario so payment can be made in person and the information contained on the brochure/chip may be transferred to the customization machine where the board can be created according to the specifications of the user.

Once ordered, the user or a third party (including an administrator of the system) can view the status of the order, for example by entering the website and entering an order number associated with the purchase. In one example, a user, after purchasing the surfboard online from the website, could return to the website and login. Once logged into the website, he or she could follow the progress of the board thru production and shipping by viewing the displayed changes in status of the order. Any manufacturing process now known or used in the future may be used by embodiments of the inventive subject matter. For example, “hand shaped” boards may be created according to the specification as well as machine made boards.

In other embodiments, the customer may select one or more attributes from a menu of predefined board styles, shapes and/or dimensions. The customer can use any combination of predefined variables or the customer can adjust any of the variables to further suit his or her needs. Using the described embodiments and their equivalents, customers are able to build for purchase boards such as surfboards and other types of boards which are made to the customer's exact specifications rather than just selecting static templates/molds or boards already in stock which are then subsequently modified by the merchant before delivery.

FIG. 4 shows an embodiment of the present inventive subject matter showing the ability of a user to select and modify characteristics of a surfboard. The same type of interface may be used to view the status of an existing order.

The system generally includes a remote customer computer station connected in a known manner via the internet with a server. The server is generally configured in a known manner to support a website for interacting with the remote computer station via an internet connection. The server is able to communicate information to and from the remote computer in a known manner to a main computer station. The computer station generally includes a processor which is operable to execute a software program stored on a memory of the main computer station. The location of the software program and the server for the website can vary. For example, it may be an embedded JavaScript program on the remote computer of the user or it may be a server side program on the website server. The main computer station is also typically connected to a display to interact with an operator at the main computer station. The remote computer and display may also be a mobile computer such as a mobile phone.

The main computer station is also connected to communicate with a computer controlled fabrication machine configured to fabricate the customized board. The software program used within the fabrication machine and/or within the computer station generally includes instructions to the processor for executing the steps of the method needed to fabricate the board.

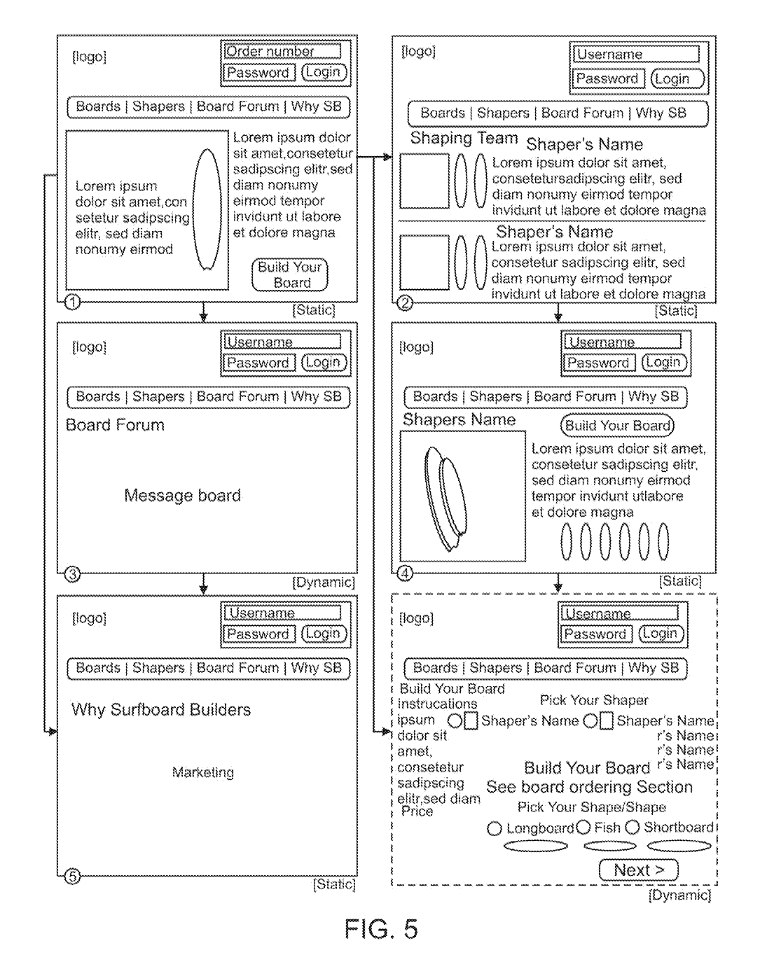

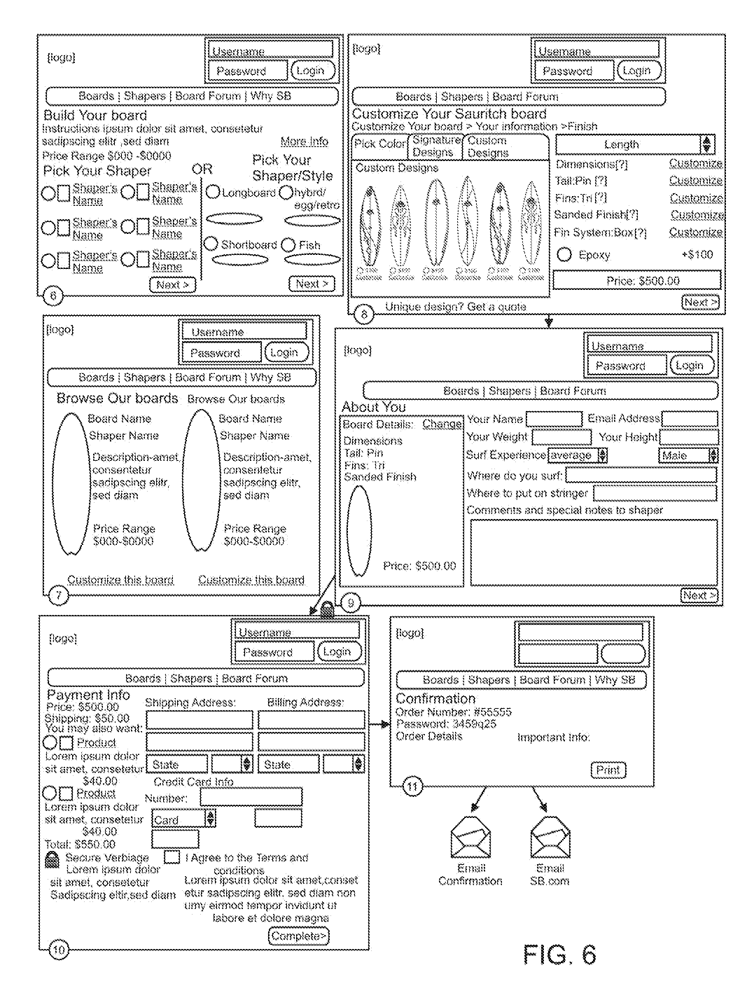

Referring now to FIGS. 5 and 6, a flow chart for a website embodiment is shown which can be used system which can be used to fabricate a surfboard from a list of attributes. A user would be presented with a series of web pages in order to first provide more information about the customization service and second to provide information on the customization of a board for the user.

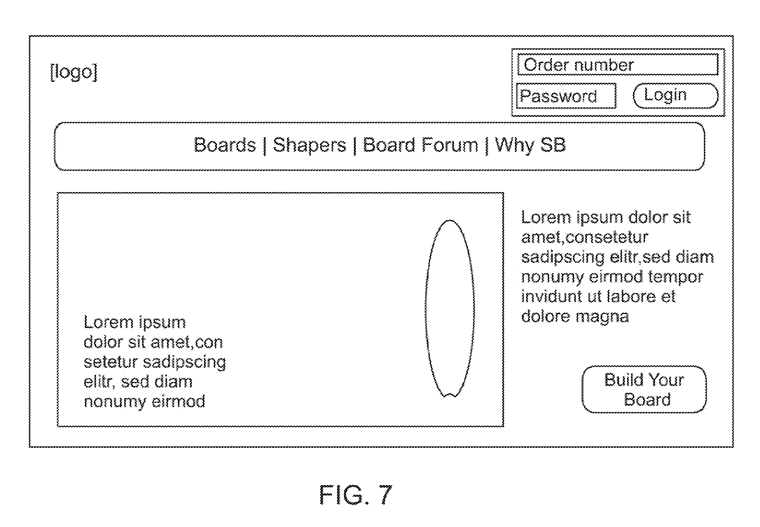

FIG. 7 is an illustration of a website page showing a list of shapers from which a user can make a selection according to an embodiment of the claimed subject matter. In other embodiments, the user may elect to bypass the shaper's predesigned templates or the user may request that a shaper review the user's final design.

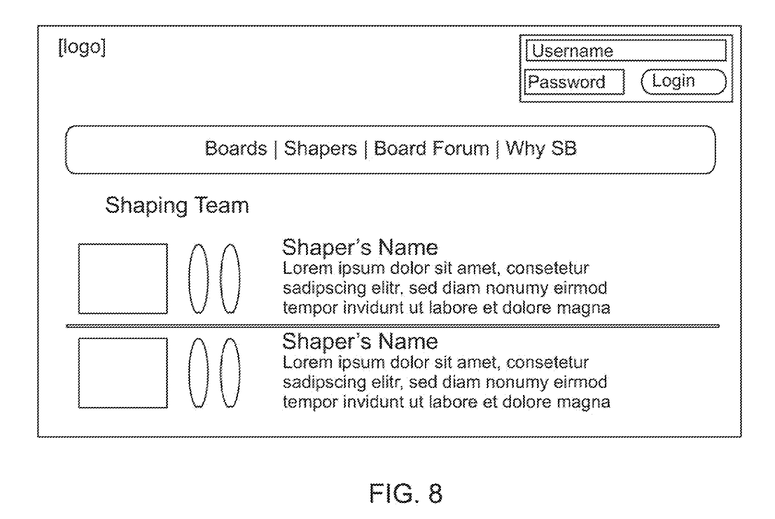

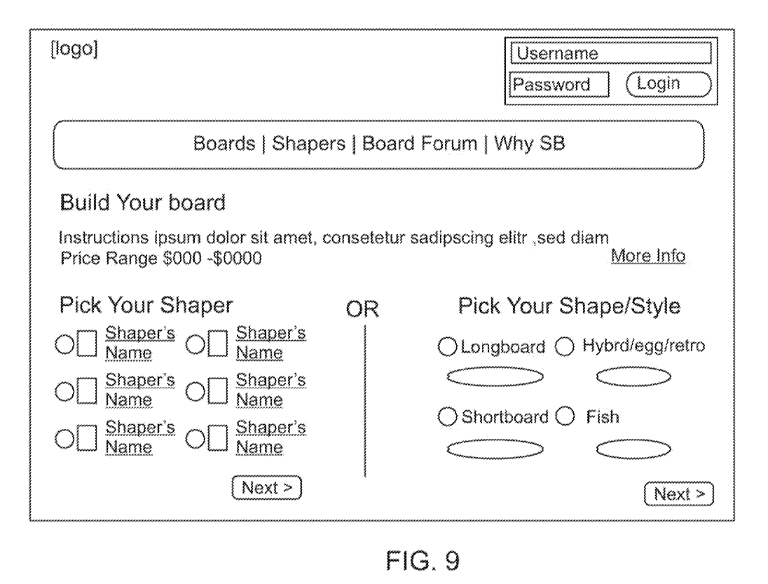

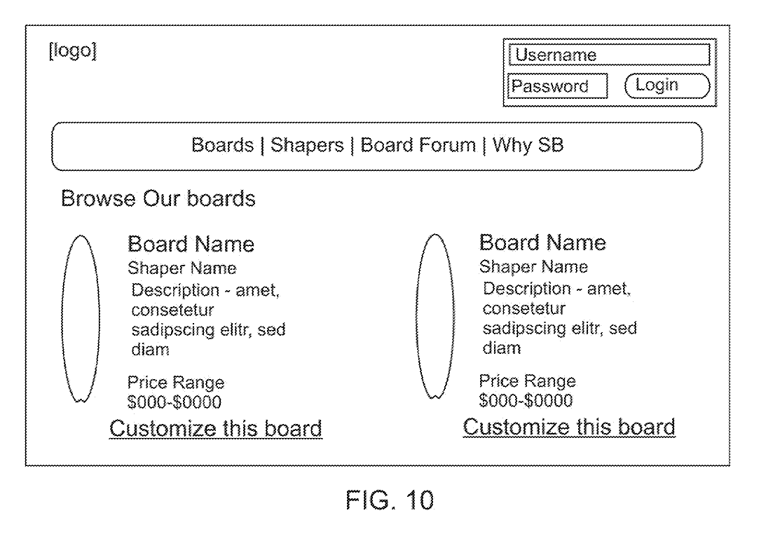

FIG. 8 is an illustration of a website page showing more detailed information relating to one of the shapers found on the website page of FIG. 7 and FIG. 9 is an illustration of a website page used to initiate the customization of a new board. FIGS. 10 through 17 show examples of selections the user is prompted to make in the board customization process.

FIG. 18 is an illustration of a website page which summarized the user's customization selections. These selections may be shared online with other users, for example in social network widgets. The selections may also be saved by the user so that they can be modified or used to place an order at a later time. Examples of information that can be contained on this page include the user's name, email, weight, height, surf experience, favorite surfing locations, sex, and other information.

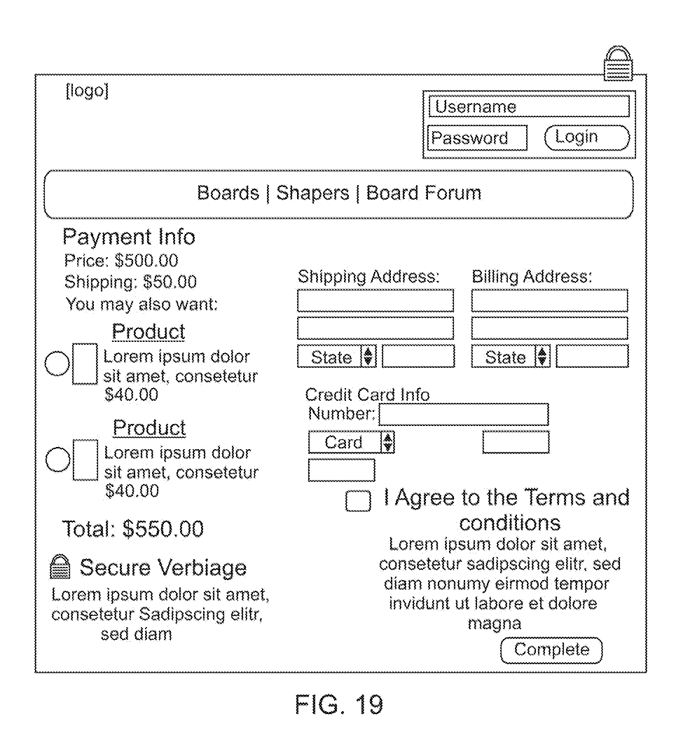

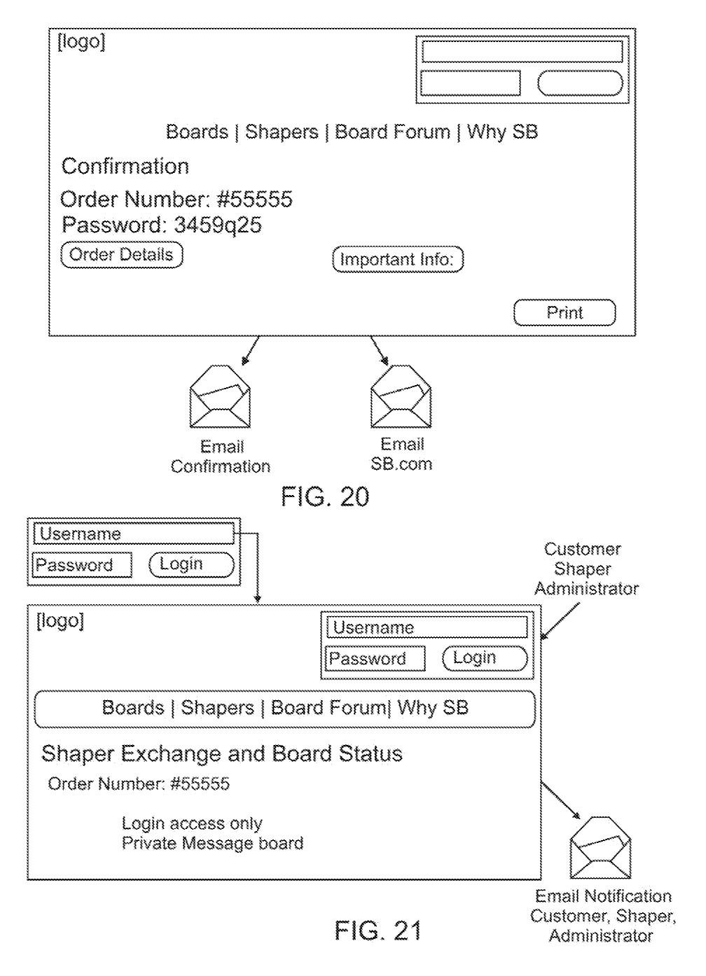

FIG. 19 is an illustration of a website page showing the payment information used to complete an order, FIG. 20 is an illustration of a website page showing the confirmation of the new order screen, and FIG. 21 is an illustration of a website page showing the message exchange feature so that customers and shapers may share information regarding the customization information.

When the order is complete, the files are sent to the fabricating machine so that the customized board can be fabricated in accordance with the customer's specifications found in the customer file. In one embodiment, the setup of the files includes locating and retrieving the stored customer files from the memory, and executing the software program to generate or create a component list for fabricating the customized board. The component list is then used to locate and retrieve the components which are used to fabricate the board. The fabrication machine and the board components may be programmed into the computer station to perform surfboard fabrication using known methods in the art such as X-Y coordinate constructions of a CNC machine. Other types of coordinate systems such as polar coordinate systems may also be used as well as any other type of fabrication machines known to those skilled in the art. When identifying placement of the respective components and the actions taken on those components from a fabrication instructions, the software program and/or fabrication machine are operable to call up the location of the board components needed and take any required action to fabricate the custom board. Assembling the customized board includes identifying the desired placement of the base board as well as any additional components required to complete the board design and coloring. In these embodiments, the software program in the fabricator machine or the computer station controlling the fabricator machine instructs the processor of the fabricator machine to communicate location and placement of the board attributes in accordance to the fabrication instructions kit translated to the respective machine language of the fabricator machine.

Embodiments of the systems and methods described above may be used to fabricate or manufacture single boards or low volumes of boards, but the methods and systems may also be used to fabricate other types of boards such as boards used for windsurfers and boards used for land sports such as skateboards.

The described embodiments illustrate are not limited as many variations of the inventive subject matter can be made without departing from the scope of the claimed subject matter.

1. A system for fabricating a customized board, comprising:
an input device for allowing a user to input information about the customized board to be fabricated;
a central processing unit operatively connected to the input device by a communications network, the central processing unit receiving said information and generating fabrication instructions in response to said information; and
a fabrication machine operatively connected to the central processing unit for fabricating the customized board in accordance with the fabrication instructions.

2. The system of claim 1 wherein the input device includes an order computer for allowing the user to input said attribute information into the system including an electronic order page to prompt the user to enter said attribute information.

3. The system of claim 2 wherein said attribute information is prompted by the electronic order page wherein said prompt includes a selection of one or more graphic images to be fabricated upon or within the customized board.

4. The system of claim 2 wherein said information defines a customer file and wherein the central processing unit includes a processor and a memory storing a software program, the software program operable to instruct the processor to:
import the customer file containing the selected attributes from the input device;
generating a fabrication file that includes instructions for the fabrication machine for selecting the at least one board component and fabricating a customized surfboard; and
sending the fabrication file to the fabrication machine wherein the fabrication machine creates a board based on said fabrication file.

5. The system of claim 1 wherein the communications network is the internet.

6. The system of claim 1 wherein the board is a board selected from one of the following group: a surfboard, a snowboard, a wake board, a hand board, a skateboard, a paddle board, and a stand up paddle board.

7. The system of claim 1 wherein the board's attributes are selected from one or more of the following: size, shape, choice of a predefined board shape and style.

8. The system of claim 1 wherein said user selects said attributes from a menu of predefined board styles, shapes and/or dimensions.

9. The system of claim 1 wherein said input information is data received in a three dimensional computer aided design file.

10. A method of fabricating a board, the method comprising the steps of:
receiving a customer file from a remote user containing design information for a customized board to be fabricated;
generating fabrication instructions for fabricating said board based on said customer file; and
fabricating said board in accordance with said fabrication instructions.

11. The method of claim 10 wherein the step of fabricating the board includes the additional steps of:
placing the board components within a fabrication machine; and
selecting the board components for fabricating the board.

12. The method of claim 10 including the additional step of downloading the fabrication instructions to said fabrication machine prior to the fabrication of the board.

13. The method of claim 12 comprising the additional steps of:
inputting fabrication information for the customized board to be fabricated, the fabrication information defining a customer file; and
transmitting the customer file to a central processing unit.

14. The method of claim 13 wherein the fabrication file is transmitted to the central processing unit over the internet.

15. The method of claim 14 wherein the fabrication file includes a graphic image of said customized board.

16. The method of claim 10 wherein the board is a board selected from one of the following group: a surfboard, a snowboard, a wake board, a hand board, a skateboard, a paddle board, and a stand up paddle board.

17. The method of claim 10 wherein the fabrication file includes one or more attributes selected from the following group: size, shape, choice of a predefined board shape and style.

18. The method of claim 17 wherein said user selects said attributes from a menu of predefined choices.

19. The method of system of claim 10 wherein said fabrication file includes one or more attributes in a three dimensional computer aided design file.

20. A computer enabled apparatus for fabricating a customized board, comprising:
an input device for allowing a user to input information on the customized board to be fabricated;
a central processing unit operatively connected to the input device by a communications network, the central processing unit receiving said information and generating fabrication instructions in response to said information; and
a fabrication machine operatively connected to the central processing unit for fabricating the customized board in accordance with the fabrication instructions.
